(19) United States
(12) Patent Application Publication
(10) Pub. No.: US 2006/0255712 A1
(43) Pub. Date: Nov. 16, 2006

(54) Light emitting apparatus, liquid crystal display apparatus and lighting apparatus

(76) Inventors: Masatsugu Masuda, Higashihiroshima-shi (JP); Hiroshi Umeda, Kitakatsuragi-gun (JP); Masaharu Kitano, Higashihiroshima-shi (JP); Takashi Oouchida, Kitakatsuragi-gun (JP)

Correspondence Address: MORRISON & FOERSTER LLP, 755 PAGE MILL RD, PALO ALTO, CA, 94304-1018, US

(21) Appl. No.: 11/407,753

(22) Filed: Apr. 19, 2006

(30) Foreign Application Priority Data
Apr. 19, 2005 (JP) 2005-121465

(51) Int. Cl. H01J 63/04; H01J 1/62

(52) U.S. Cl. 313/485; 313/486; 313/512

(57) ABSTRACT

A light emitting apparatus includes: a semiconductor light emitting element capable of emitting light of two wavelength components; and a fluorescent material section, having a fluorescent material contained therein, capable of emitting light, the light being radiated as a result of fluorescence from the fluorescent material when the fluorescent material is excited by the two wavelength components, wherein the two wavelength components and the wavelength component resulting from the fluorescence are adjusted so as to be set at an arbitrary color temperature on a characteristic curve of black-body radiation.

This Nonprovisional application claims priority under 35 U.S.C. §119(a) on Patent Applications No. 2005-121465 filed in Japan on Apr. 19, 2005, the entire contents of which are hereby incorporated by reference.

### BACKGROUND OF THE INVENTION

1. Field of the Invention

The present invention relates to: a light emitting apparatus used for obtaining white light using a fluorescent material which wavelength-converts light emitted from a light emitting diode (LED) as a semiconductor light emitting element; a liquid crystal display apparatus mounted on an electronic information device (e.g., a liquid crystal television apparatus, a personal computer, a PDA (personal display association) and a cellular phone) using the light emitting apparatus as a backlight of a liquid crystal display screen; and a lighting apparatus in doors or out of doors using the light emitting apparatus as a light source.

2. Description of the Related Art

Conventionally, the light emitting apparatus of this kind is used, for example, as a light source for backlight of a liquid crystal display. Light emitted from the light emitting diode (LED) and light emitted from the fluorescent material excited by the LED light are used for obtaining white light.

At present, the five following methods (1) to (5) are considered as methods used for obtaining the white light using the light emitting diode and the fluorescent material.

(1) A method for combining blue LED light, green LED light and red LED light emitted from respective light emitting diodes.

(2) A method for combining blue light emitted from a light emitting diode and yellow light emitted from a fluorescent material excited by the LED light.

(3) A method for combining blue LED light emitted from a light emitting diode, and green light and red light emitted from fluorescent materials, respectively, excited by the blue LED light.

(4) A method for combining blue light and yellow light emitted from fluorescent materials, respectively, excited by near-ultraviolet light and/or ultraviolet light.

(5) A method for combining blue light, green light and red light emitted from fluorescent materials, respectively, excited by near-ultraviolet light and/or ultraviolet light.

Recently, an InGaN light emitting diode from which light of two color components (a secondary peak occurs adjacent to the main peak in the blue portion of the spectrum) is emitted is mass-produced. Thus, the white light described in (2) can be obtained using one light emitting diode. Natural light is represented by using a color temperature of black-body radiation. In the field of lighting, lighting using the light emitting diode attracts interest.

As an example in which the method described in (1) is performed using one light emitting diode, Reference 1 discloses a light emitting diode in which light having color components of three primary colors (i.e., blue, green and red), respectively, is emitted from one InGaN light emitting diode. In Reference 1, as a light emitting diode in which semiconductor layers made of an InGaN material are laminated on a substrate, a second semiconductor layer made of AlN or In_{y}Ga_{1-y}N (0≦y≦1) is formed on a first semiconductor layer made of InₓGa₁₋ₓN (0≦x≦1) and a third semiconductor layer made of In_{z}Ga_{1-z}N (0≦z≦1) is formed on the second semiconductor layer. The second semiconductor layer is grown at a lower temperature than the first semiconductor layer. The third semiconductor layer is grown at a higher temperature than the second semiconductor layer

As an example of the method described in (5), Reference 2 discloses a light emitting apparatus in which blue light, green light and red light emitted from three fluorescent materials, respectively, excited by one LED light are used for obtaining white light. In Reference 2, LED light having an emission wavelength of 390 nm to 420 nm is emitted from a light emitting diode. Red light having a main peak in an emission wavelength range of 600 nm to 670 nm is emitted from a first fluorescent material excited by the LED light. Green light having a main peak in an emission wavelength range of 500 nm to 540 nm is emitted from a second fluorescent material excited by the LED light. Blue light having a main peak in an emission wavelength range of 410 nm to 480 nm is emitted from a third fluorescent material excited by the LED light. The red light, the green light and the blue light, respectively, emitted from each fluorescent material are mixed so as to obtain white light.

[Reference 1] Japanese Laid-Open Publication No. 11-145513

[Reference 2] Japanese Laid-Open Publication No. 2002-171000

### SUMMARY OF THE INVENTION

In the conventional method (2) in which the blue LED light emitted from the light emitting diode and the yellow light emitted from the fluorescent material excited by the blue LED light are combined, it is easy to control the balance of color intensity since three primary colors are not used. However, natural light having white characteristics can be emitted at only one point along the characteristic curve of black-body radiation. Thus, an arbitrary natural light having white characteristics along the characteristic curve of black-body radiation cannot be not emitted. In another conventional method (4) in which the blue light and the yellow light emitted from fluorescent materials, respectively, excited by ultraviolet light and/or near-ultraviolet light are combined, red which is one of the three primary colors is omitted. Thus, an arbitrary natural light having white characteristics cannot be emitted along the characteristic curve of black-body radiation. As a result, light having more characteristics which are closer to that of natural white light cannot be emitted.

Therefore, as conventional methods for reproducing the color temperature of black-body radiation as an arbitrary natural light using a light emitting diode, the methods (1), (3) and (5) are used, respectively, since the three primary colors are used as a set in each method. However, in each method (1), (3) and (5), it is necessary to control three wavelengths or four wavelengths of the three primary colors. For example, in the method in which blue LED light, green LED light and red LED light emitted from respective light emitting diodes are combined as disclosed in the conventional method (1) and Reference 1, it is difficult to control the three primary colors and to emit an arbitrary natural light having white characteristics along the characteristic curve of black-body radiation since it is necessary to accurately control the balance of each color intensity of the respective three primary colors.

In the methods disclosed in (3), (5) and Reference 2, there is a disadvantage in emission efficiency since absorption and emission of two wavelengths occur between two kinds of fluorescent materials. Furthermore, it is difficult to uniformly mix the two kinds of fluorescent materials in a resin material due to differences in specific gravity of each of the fluorescent materials. As a result, a difference in color intensity between each of the fluorescent colors produced occurs. Therefore, a problem occurs in that it is difficult to mass-produce.

The present invention is intended to solve the problems described above. The objective of the present invention is to provide a light emitting apparatus capable of emitting an arbitrary natural light along the characteristic curve of black-body radiation, with which it is easy to control the balance of each color intensity, the light emitting apparatus having advantages in emission efficiency and in capability to mass-produce; a liquid crystal display apparatus mounted on an electronic information device using the light emitting apparatus as a backlight of a liquid crystal display screen; and a lighting apparatus using the light emitting apparatus as a light source.

A light emitting apparatus according to the present invention includes: a semiconductor light emitting element capable of emitting light of two wavelength components; and a fluorescent material section, having a fluorescent material contained therein, capable of emitting light, the light emitted from the fluorescent material when the fluorescent material is excited by at least one of the two wavelength components, wherein the two wavelength components and the wavelength component resulting from the fluorescence are adjusted so as to be set at an arbitrary color temperature on a characteristic curve of black-body radiation, thereby the objective described above being achieved.

Preferably, in a light emitting apparatus according to the present invention, the semiconductor light emitting element is a light emitting diode (element).

Furthermore, preferably, in a light emitting apparatus according to the present invention, the light emitting diode is an InGaN light emitting diode.

Furthermore, preferably, in a light emitting apparatus according to the present invention, the two wavelength components are two colors in a color range between blue and yellow, and the wavelength component resulting from the fluorescence is red.

Furthermore, preferably, in a light emitting apparatus according to the present invention, the two wavelength components are two colors, and the two colors are blue and a color within a color range between green and yellow.

Furthermore, preferably, in a light emitting apparatus according to the present invention, the two wavelength components are two colors, and the two colors are blue and yellow.

Furthermore, preferably, in a light emitting apparatus according to the present invention, in the fluorescent material section, the content of the fluorescent material contained in a resin is adjusted such that a combined light of the three wavelength components is set at a color temperature on the characteristic curve of black-body radiation.

Furthermore, preferably, in a light emitting apparatus according to the present invention, in the fluorescent material section, the thickness of the resin having the fluorescent material contained therein is adjusted such that a combined light of the three wavelength components is set at a color temperature on the characteristic curve of black-body radiation.

Furthermore, preferably, in a light emitting apparatus according to the present invention, the fluorescent material includes one or more fluorescent materials from a group of fluorescent materials, the fluorescent materials being represented as
CaAlSiN₃: Eu2+;
M₂O₂S: Eu; (where M is one or elements selected from La, Gd and Y),
0.5MgF₂.3.5MgO.GeO₂: Mn;
Y(P,V)O₄: Eu; and
YVO₄: Eu.

Furthermore, preferably, in a light emitting apparatus according to the present invention, the semiconductor light emitting element is provided at the bottom of a concaved portion at the upper surface of a case member, and a resin mixed with the fluorescent material is to provided to fill the inside of the concaved portion at the front of a light-emitting side of the semiconductor light emitting element, the inside of concaved portion being the fluorescent material section.

A liquid crystal display apparatus according to the present invention uses the aforementioned light emitting apparatus according to the present invention as a backlight.

A lighting apparatus according to the present invention uses the aforementioned light emitting apparatus according to the present invention as a light source.

Hereinafter, the function of the present invention, having the aforementioned structure, will be described.

The present invention includes a semiconductor light emitting element (e.g., a light emitting diode) and a fluorescent material section containing a fluorescent material therein. The semiconductor light emitting element is capable of emitting light of two wavelength components. Light can be emitted from the fluorescent material excited by the two wavelength components. The two wavelength components of the light emitted from the semiconductor light emitting element and the wavelength component of the light emitted from the fluorescent material are adjusted so as to be set at an arbitrary color temperature on the characteristic curve of black-body radiation.

In this case, the light emitted from the fluorescent material can be controlled by controlling light of the two wavelength components emitted from the semiconductor light emitting element. Thus, there is no need to control three wavelengths or four wavelengths of the primary colors simultaneously, as was conventionally required. Therefore, it is easier than was conventionally possible to control each color component so as to be set at an arbitrary color temperature on the characteristic curve of black-body radiation. When the content of the fluorescent material contained in a resin and the thickness of the resin having the fluorescent material contained therein are adjusted, the resulting light emitted from the combination of the three wavelength components of the light emitted from the semiconductor light emitting element and the wavelength component of the light emitted from the fluorescent material is easily adjusted. Thus, the combined light can be easily set at an arbitrary color temperature on the characteristic curve of black-body radiation.

Furthermore, there is an advantage in emission efficiency of the apparatus in the present invention when compared to the absorption and emission of two wavelength components which are observed in conventional apparatuses since only one kind of fluorescent material is used in the apparatus of the present invention. Also, there is no need to uniformly mixing two kinds of fluorescent materials in a resin material as was required with the conventional apparatuses. Thus, the difference in color intensity between each fluorescent color produced does not occur. Therefore, the problem in achieving the mass production capability, which occurs with conventional apparatuses, is solved by the present invention.

As described above, the present invention can easily control the balance of each color intensity and has an advantage in emission efficiency and in capability to mass-produce. Also, the present invention can emit an arbitrary natural light along the characteristic curve of black-body radiation.

These and other advantages of the present invention will become apparent to those skilled in the art upon reading and understanding the following detailed description with reference to the accompanying figures.

### BRIEF DESCRIPTION OF THE DRAWINGS

FIG. 1 is a diagram showing a structure of a light emitting apparatus according to an embodiment of the present invention. (a) is a plain view thereof. (b) is a cross-sectional view cut by A-A′ line of (a).

FIG. 2 is a diagram of chromaticity coordinate showing chips A, B and C on the CIE chromaticity coordinate and the characteristic curve of black-body radiation.

FIG. 3 is a diagram showing typical emission spectra when light emitting apparatuses according to the present embodiment are operated at 20 mA.

### DESCRIPTION OF THE PREFERRED EMBODIMENTS

Hereinafter, an embodiment of a light emitting apparatus according to the present invention will be described with reference to the accompanying drawings.

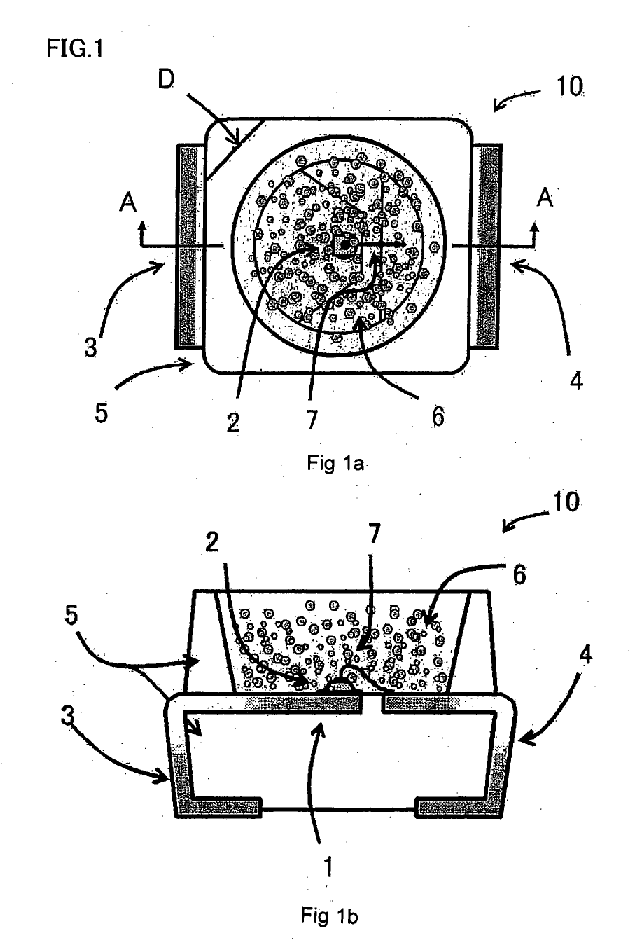

FIG. 1 is a diagram showing a structure of the light emitting apparatus according to the embodiment of the present invention. (a) is a plain view thereof. (b) is a cross-sectional view of (a) cut by A-A′ line.

In FIGS. 1(a) and 1(b), a light emitting apparatus 10 according to the present embodiment has an LED chip 2 provided on a metal base frame 1. Each terminal of the LED chip 2 is connected to an anode terminal 3 and a cathode terminal 4, respectively. The anode terminal 3 and the cathode terminal 4 are a part of the metal frame and protrude out from a resin case 5. The base frame 1 is integrated with the anode terminal 3. At the frontal side of a light-emitting face (upward direction of opening side of a concaved portion) of the LED chip 2 provided at the bottom of the concaved portion in the center of the upper surface of the resin case 5, a resin mixed with a designated fluorescent material 6 for a red fluorescence is provided to fill the inside of the concaved portion. The inside of the concaved portion is used as a fluorescent material section. Therefore, Light emitted from the LED chip 2 is capable of exciting the fluorescent material 6. A designated terminal of the LED chip 2 can be fixed on the base frame 1 with an electrically conductive adhesive and can be connected to the anode terminal 3. The cathode terminal 4 and the designated terminal of the LED chip 2 are bonded by an Au wire 7 so as to be connected to each other. The base frame 1, the LED chip 2, the anode terminal 3 and the cathode terminal 4 are packaged with each portion of the anode terminal 3 and the cathode terminal 4 being pulled out of the resin case 5 while the resin is sealing the inside of the case 5. Reference numeral D depicts a portion of the resin case which is cut and recessed. This is to mark an anode side.

A light emitting diode (not shown) is mounted on the LED chip 2. The light emitting diode is capable of emitting light of two wavelength components (blue and green to yellow). The light emitting diode can be constructed by an InGaN light emitting diode. The light emitting diode capable of emitting light of two wavelengths is combined with the fluorescent material 6 for emitting light emanating from red fluorescence. As a result, light of three wavelengths for respective three primary colors can be obtained.

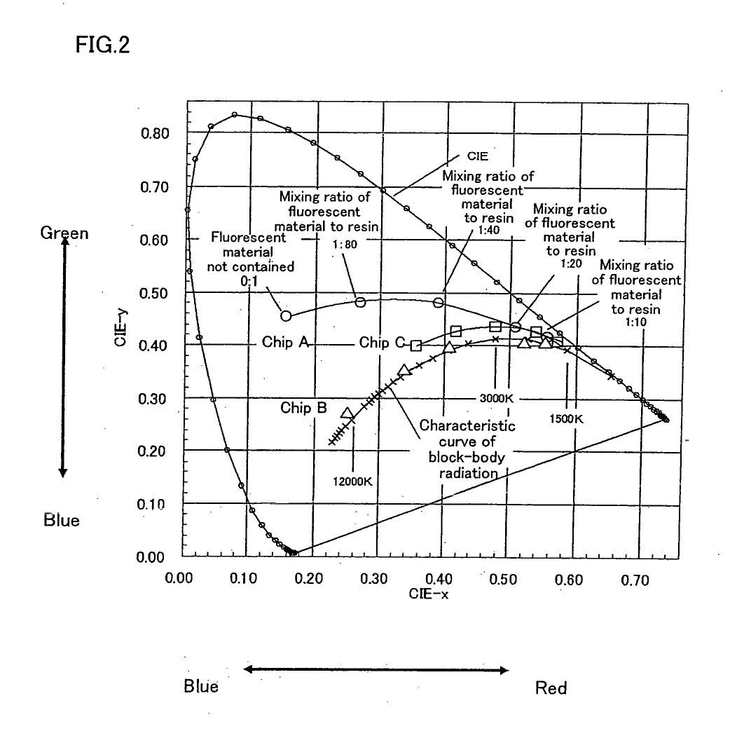

In a commonly used fluorescent material, the shorter the wavelength of light emitted from the fluorescent material is, the better the excitation efficiency thereof is. In this case, blue component of the light emitted from the light emitting diode mounted on the LED chip 2 is absorbed to a greater extent by the fluorescent material 6 than the green to yellow component. Thus, when the mixing ratio of the fluorescent material 6 to the sealing resin or the thickness of the resin containing the fluorescent material 6 is increased, the chromaticity of the component for red fluorescence become stronger after the chromaticity of the green to yellow wavelength component become stronger than the chromaticity of the blue wavelength component. Thereafter, the chromaticity of the component for red fluorescence follows the characteristic curve of black-body radiation. The case of an InGaN light emitting diode from which light of two color components (two primary colors of the three primary colors) is emitted is referred to. When the two wavelength components, blue and the green to yellow, are combined with the component emanating from of the fluorescent material 6 for red fluorescence, chromaticity coordinates can be obtained on the characteristic curve of black-body radiation in the range approximately between 3000K (Kelvin) and 1500K (Kelvin) on the CIE chromaticity coordinate shown in FIG. 2. In particular, the case of an InGaN light emitting diode from which light of two color components is emitted is referred to. When the combination of the two wavelength components, blue and yellow, are combined with the component emanating from the fluorescent material 6 for red fluorescence, chromaticity coordinates can be obtained on the characteristic curve of black-body radiation in the range approximately between 12000K (Kelvin) and 1500K (Kelvin) on the CIE chromaticity coordinate shown in FIG. 2.

Herein, a specific example of the light emitting apparatus 10 according to the present invention, which is prototyped as an LED device (hereinafter, referred to as “TOP LED device”), the LED device having the structure shown in FIG. 1, will be described.

In an InGaN light emitting diode from which light of two color components is emitted, the combination of a peak wavelength 440 nm of a blue component and a peak wavelength 540 nm of a green color component are shown as chip A with ◯ mark in FIG. 2. In a similar manner, the combination of a peak wavelength 440 nm of a blue component and a peak wavelength 590 nm of a yellow color component, in which the emission intensity of the blue component is stronger than the yellow color component, is shown as chip B with Δ mark in FIG. 2, and the emission intensity of the yellow color component is stronger than the blue component, is shown as chip C with □ mark in FIG. 2, respectively. Chromaticity coordinates for the LED chip 2 are at chip A (0.16, 0.46), chip B (0.25, 0.26) and chip C (0.35, 0.40).

As a fluorescent material which emits red light, for example, CaAlSiN3: Eu2+ is used as the fluorescent material 6. The chromaticity coordinates of light emitted from the fluorescent material 6 are at (0.59, 0.40). The fluorescent material 6 is held by a silicone resin. TOP LED devices mounted on the light emitting apparatuses 10 according to the present embodiment are prototyped, in which the mixing ratio of the fluorescent material 6 to the silicone resin is changed in each case.

First, the LED chip 2 is sequentially die-bonded and wire-bonded on the lead frame which is package-molded. Next, the five mixing ratios (0:1, 1:80, 1:40, 1:20 and 1:10) of the fluorescent material 6 to the resin are made, respectively. A resin mixed with the fluorescent material 6 is cast-molded into the concaved portion of the package attached to the frame to which the step of wire-bonding is completed, and the cast-molded resins together with the fluorescent material 6 are thermally cured at 150 degrees Celsius. Finally, each package is separated from each other and the TOP LED device is completed.

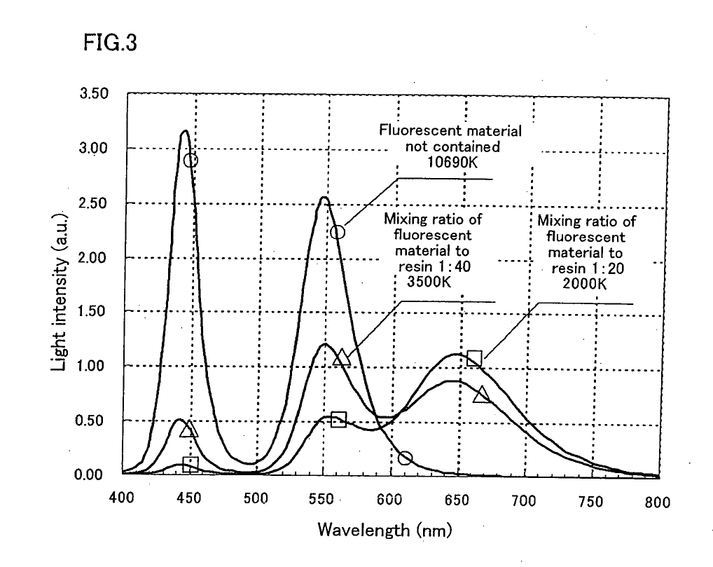

Typical emission spectra of the TOP LED devices operated at 20 mA, which have been produced as described above, are shown in FIG. 3.

As the mixing ratio of the fluorescent material 6 to the resin increases, the emission intensity of the blue LED wavelength decreases to a greater extent than the yellow green LED wavelength. Corresponding to this, wavelength of the red light emitted from the fluorescent material increases. As the mixing ratio of the fluorescent material 6 to the resin increases, the emission intensity is high in the order of red, yellow green and blue. Spectra obtained from a pseudo black-body with an excellent controllability are reproduced. The spectrum of a black-body radiation from a black-body is continuous by nature. However, in the case of the black-body, the black-body radiation does not show a fluctuating spectral curve as observed in the case of a pseudo black-body. Therefore, the black-body radiation spectrum produced by a pseudo black-body is herein referred to as a pseudo black-body radiation spectrum.

Chromaticity coordinates of the TOP LED devices are shown in FIG. 2 when the TOP LED devices, which are prototyped this time, are operated at 20 mA. As the mixing ratio of the fluorescent material 6 to the resin increases, the chromaticity coordinates of the light emitted from the TOP LED device operated at 20 mA converge to the chromaticity coordinates of the light emitted from the fluorescent material 6. As described above, among wavelength components of the light emitted from the LED, the yellow green component of the light is absorbed by the fluorescent material 6 to a lesser extent than the blue component of the light. Thus, the chromaticity coordinates of the LED chip 2 itself converge to the chromaticity coordinates of the fluorescent material 6 once CIE-Y component increases proportionally with the increase of the mixing ratio of the fluorescent material 6 to the resin.

With such a TOP LED device, when chromaticity coordinates of the light emitted from the LED chip 2 itself are selected from chromaticity coordinates on the characteristic curve of black-body radiation, an LED device having chromaticity coordinates on the characteristic curve of black-body radiation can be obtained in the manner described above.

As described above, a light emitting apparatus according to the present embodiment includes: an LED chip 2, having a semiconductor light emitting element (light emitting diode) mounted thereon, capable of emitting light of two wavelength components (i.e., blue and green); and a fluorescent material section, having a fluorescent material 6 contained in a resin contained therein, capable of emitting red light, the red light being emitted from the fluorescent material when the fluorescent material is excited by the two wavelength components (the fluorescent material may be excited by at least one of the two wavelength components). The two wavelength components of the light emitted from the semiconductor light emitting element and the wavelength component of the light emitted from the fluorescent material 6 are combined so as to be set at an arbitrary color temperature on the characteristic curve of black-body radiation. In this case, it is easier to control the balance of the each color intensity. Also, there is an advantage in emission efficiency and capability to mass-produce.

The fluorescent material 6 in the present embodiment uses CaAlSiN₃: Eu2+. However, it can also include one or more fluorescent materials from a group of fluorescent materials, the fluorescent materials being represented as
CaAlSiN₃: Eu2+;
M₂O₂S: Eu; (where M is one or elements selected from La, Gd and Y),
0.5MgF₂.3.5MgO.GeO₂: Mn;
Y(P,V)O₄: Eu; and
YVO₄: Eu.

Although no specific example has been given in the embodiment described above, a liquid crystal display apparatus for: an electronic information device (e.g., a liquid crystal television apparatus and a PDA and a cellular phone) using the light emitting apparatus according to the present invention as a backlight of a liquid crystal display screen; and an electric information device (e.g., a personal computer) using the light emitting apparatus according to the present invention as a backlight of a liquid crystal monitor can be obtained. A lighting apparatus using the light emitting apparatus as a light source can be obtained as well. Even in the liquid crystal display apparatus and the lighting apparatus, according to the light emitting apparatus of the present invention, it is easier to control the balance of each color intensity, and there is an advantage in emission efficiency and capability to mass-produce. Furthermore, the effect that an arbitrary natural light along the characteristic curve of black-body can be emitted can be obtained using the light emitting apparatus according to the present invention.

As described above, the present invention is exemplified by the use of its preferred embodiments. However, the present invention should not be interpreted solely based on the embodiments described above. It is understood that the scope of the present invention should be interpreted solely based on the claims. It is also understood that those skilled in the art can implement equivalent scope of technology, based on the description of the present invention and common knowledge from the description of the detailed preferred embodiments of the present invention. Furthermore, it is understood that any patent, any patent application and any references cited in the present specification should be incorporated by reference in the present specification in the same manner as the contents are specifically described therein.

### INDUSTRIAL APPLICABILITY

According to the present invention, in the field of a light emitting apparatus used for obtaining white light by using a fluorescent material which wavelength-converts an emitted light from a light emitting diode (LED) as a semiconductor light emitting element; a liquid crystal display apparatus mounted on an electronic information device (e.g., a liquid crystal television apparatus, a personal computer, a PDA and a cellular phone) using the light emitting apparatus as a backlight of a liquid crystal display screen; and a lighting apparatus in doors or out of doors using the light emitting apparatus as a light source, it is easier to control the balance of each color intensity, and there is an advantage in emission efficiency and capability to mass-produce. Furthermore, an arbitrary natural light along the characteristic curve of black-body can be emitted.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A light emitting apparatus, comprising:
a semiconductor light emitting element capable of emitting light of two wavelength components; and
a fluorescent material section, having a fluorescent material contained therein, capable of emitting light, the light emitted from the fluorescent material when the fluorescent material is excited by at least one of the two wavelength components,
wherein the two wavelength components and the wavelength component resulting from the fluorescence are adjusted so as to be set at an arbitrary color temperature on a characteristic curve of black-body radiation.

2. A light emitting apparatus according to claim 1, wherein the semiconductor light emitting element is a light emitting diode.

3. A light emitting apparatus according to claim 2, wherein the light emitting diode is an InGaN light emitting diode.

4. A light emitting apparatus according to claim 2, wherein the two wavelength components are two colors in a color range between blue and yellow, and the wavelength component resulting from the fluorescence is red.

5. A light emitting apparatus according to claim 4, wherein the two wavelength components are two colors, and the two colors are blue and a color within a color range between green and yellow.

6. A light emitting apparatus according to claim 4, wherein the two wavelength components are two colors, and the two colors are blue and yellow.

7. A light emitting apparatus according to claim 1, wherein the two wavelength components are two colors in a color range between blue and yellow, and the wavelength component resulting from the fluorescence is red.

8. A light emitting apparatus according to claim 7, wherein the two wavelength components are two colors, and the two colors are blue and a color within a color range between green and yellow.

9. A light emitting apparatus according to claim 7, wherein the two wavelength components are two colors, and the two colors are blue and yellow.

10. A light emitting apparatus according to claim 1, wherein in the fluorescent material section, the content of the fluorescent material contained in a resin is adjusted such that a combined light of the three wavelength components is set at a color temperature on the characteristic curve of black-body radiation.

11. A light emitting apparatus according to claim 10, wherein in the fluorescent material section, the thickness of the resin having the fluorescent material contained therein is adjusted such that a combined light of the three wavelength components is set at a color temperature on the characteristic curve of black-body radiation.

12. A light emitting apparatus according to claim 11 wherein the fluorescent material includes one or more fluorescent materials from a group of fluorescent materials, the fluorescent materials being represented as
CaAlSiN₃: Eu2+;
M₂O₂S: Eu; (where M is one or more elements selected from La, Gd and Y),
0.5MgF₂.3.5MgO.GeO₂: Mn;
Y(P,V)O₄: Eu; and
YVO₄: Eu.

13. A light emitting apparatus according to claim 10 wherein the fluorescent material includes one or more fluorescent materials from a group of fluorescent materials, the fluorescent materials being represented as
CaAlSiN₃: Eu2+;
M₂O₂S: Eu; (where M is one or more elements selected from La, Gd and Y),
0.5MgF₂.3.5MgO.GeO₂: Mn;
Y(P,V)O₄: Eu; and
YVO₄: Eu.

14. A light emitting apparatus according to claim 1, wherein in the fluorescent material section, the thickness of the resin having the fluorescent material contained therein is adjusted such that a combined light of the three wavelength components is set at a color temperature on the characteristic curve of black-body radiation.

15. A light emitting apparatus according to claim 14 wherein the fluorescent material includes one or more fluorescent materials from a group of fluorescent materials, the fluorescent materials being represented as
CaAlSiN₃: Eu2+;
M₂O₂S: Eu; (where M is one or more elements selected from La, Gd and Y),
0.5MgF₂.3.5MgO.GeO₂: Mn;
Y(P,V)O₄: Eu; and
YVO₄: Eu.

16. A light emitting apparatus according to claim 1 wherein the fluorescent material includes one or more fluorescent materials from a group of fluorescent materials, the fluorescent materials being represented as
CaAlSiN₃: Eu2+;
M₂O₂S: Eu; (where M is one or more elements selected from La, Gd and Y),
0.5MgF₂.3.5MgO.GeO₂: Mn;
Y(P,V)O₄: Eu; and
YVO₄: Eu.

17. A light emitting apparatus according to claim 1, wherein the semiconductor light emitting element is provided at the bottom of a concaved portion at the upper surface of a case member, and a resin mixed with the fluorescent material is to provided to fill the inside of the concaved portion at the frontal side of a light-emitting face of the semiconductor light emitting element, the inside of concaved portion being the fluorescent material section.

18. A liquid crystal display apparatus using the light emitting apparatus according to claim 1 as a backlight.

19. A lighting apparatus using the light emitting apparatus according to claim 1 as a light source.
